(19) United States
(12) Patent Application Publication
(10) Pub. No.: US 2022/0218082 A1
(43) Pub. Date: Jul. 14, 2022

(54) Laptop Cover

(71) Applicant: Connie Fiske, Medway, ME (US)

(72) Inventor: Connie Fiske, Medway, ME (US)

(21) Appl. No.: 17/566,215

(22) Filed: Dec. 30, 2021

Related U.S. Application Data
(60) Provisional application No. 63/135,192, filed on Jan. 8, 2021.

(51) Int. Cl. A45C 11/00; A45C 13/02

(52) U.S. Cl. CPC A45C 11/00; G06F 1/1616; A45C 2011/003; A45C 13/02

(57) ABSTRACT

A laptop cover is provided. The device includes a rigid housing including a base having a planar upper surface. A plurality of sidewalls extend from a perimeter of the base defining an open end opposite the base, wherein an interior volume of the housing is dimensioned to receive a laptop computer therein. A notch is disposed through one sidewall of the plurality of sidewalls, wherein the notch is dimensioned to receive a cable therethrough. The notch includes an open lower end extending through a distal end of the sidewall. In some embodiments, a storage compartment is disposed within the interior volume on an interior surface of the base.

### CROSS REFERENCE TO RELATED APPLICATIONS

This application claims the benefit of U.S. Provisional Application No. 63/135,192 filed on Jan. 8, 2021. The above identified patent application is herein incorporated by reference in its entirety to provide continuity of disclosure.

### BACKGROUND OF THE INVENTION

The present invention relates to portable computing device containers. More particularly, the present invention pertains to a rigid cover configured to encase a laptop or other portable computing device upon a support surface.

Many individuals utilize laptops, tablets, and other electronic devices on a regular basis, however, over time, such devices may become damaged when not properly stored in a carrying case or other storage location. Oftentimes, individuals refrain from properly storing the portable device as they will be using it again shortly, and frequently storing and retrieving the device can become frustrating. However, leaving a device exposed on a table or other surface risks damage from various outside sources, such as pets, spills, falling objects, and the like. Furthermore, many such storage locations merely reduce the scope of damage caused to a portable device via impact, sustained weight, or other harmful activities with padding, rather than fully preventing it. Over time, even reduced damage can accumulate to potentially risk complete failure of the device. Therefore, there is a need for a rigid cover capable of preventing weight and impact damage to a portable electronic device, while being quickly and easily secured over the device between uses.

In light of the devices disclosed in the known art, it is submitted that the present invention substantially diverges in design elements from the known art and consequently it is clear that there is a need in the art for an improvement to existing portable computing device containers. In this regard, the instant invention substantially fulfills these needs.

### SUMMARY OF THE INVENTION

In view of the foregoing disadvantages inherent in the known types of portable computing device containers now present in the known art, the present invention provides a laptop cover wherein the same can be utilized for providing convenience for the user when protecting a laptop or other portable computing device on a table or other support surface when the laptop is temporarily not in use.

The present system comprises a rigid housing including a base having a planar upper surface. A plurality of sidewalls extend from a perimeter of the base defining an open end opposite the base, wherein an interior volume of the housing is dimensioned to receive a laptop computer therein. A notch is disposed through one sidewall of the plurality of sidewalls, wherein the notch is dimensioned to receive a cable therethrough. The notch further includes an open lower end extending through a distal end of the sidewall. In some embodiments, a storage compartment is disposed within the interior volume on an interior surface of the base.

In some embodiments, the base is rectangular defining a front side and a rear side of identical length and a pair of lateral sides of identical length. In another embodiment, a handle is affixed to a front sidewall of the plurality of sidewalls. In other embodiments, the handle comprises a flexible strap affixed to the front sidewall at opposing ends of the flexible strap. In yet another embodiment, the notch is disposed through a lateral sidewall of the plurality of sidewalls. In some embodiments, the notch comprises an arcuate upper end. In another embodiment, a plurality of feet is disposed along a lower surface of the plurality of sidewalls. In other embodiments, the plurality of feet comprise a material configured to frictionally engage a support surface. In yet another embodiment, a padded layer is disposed about an exterior of the housing. In some embodiments, the storage compartment comprises a pocket extending between opposing lateral sides of the base. In another embodiment, the storage compartment includes a plurality of cylindrical receptacles.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the laptop cover.

FIG. 2 shows a partial cutaway side perspective view of an embodiment of the laptop cover.

FIG. 3 shows a lower plan view of an embodiment of the laptop cover.

FIG. 4 shows a perspective view of an embodiment of the laptop cover in use.

### DETAILED DESCRIPTION OF THE INVENTION

Reference is made herein to the attached drawings. Like reference numerals are used throughout the drawings to depict like or similar elements of the laptop cover. The figures are intended for representative purposes only and should not be considered to be limiting in any respect.

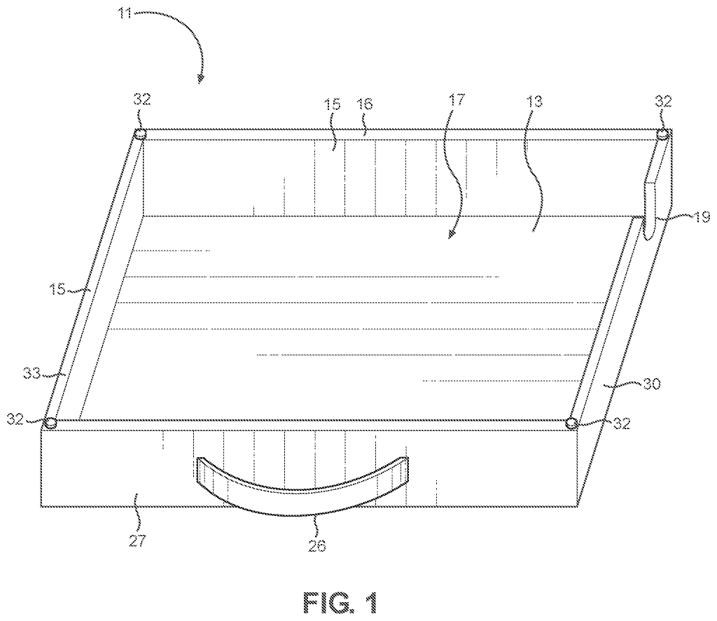

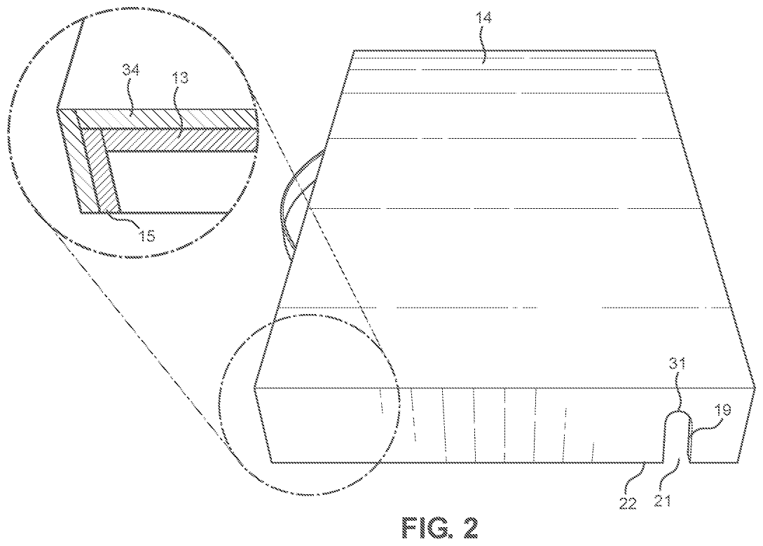

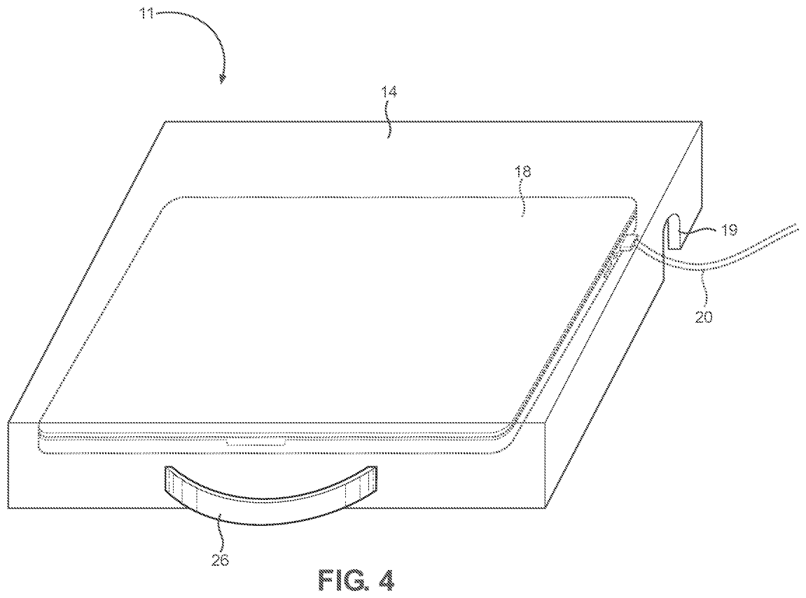

Referring now to FIG. 1, there is shown a perspective view of an embodiment of the laptop cover. The laptop cover 11 comprises a rigid housing having a base 13 and a plurality of sidewalls 15 extending perpendicularly from a perimeter of the base 13, defining an open end 16 opposite the base 13. In the illustrated embodiment, the base 13 comprises a rectangular cross-section having a front side opposite a rear side and a pair of opposing lateral sides, wherein the pair of opposing lateral sides are of identical length and the front side is of an identical length as the rear side. In this manner, the laptop cover 11 is dimensioned to enclose the stereotypical form factor of a laptop or other electronic device. An interior volume 17 is defined between the base 13 and the plurality of sidewalls 15, wherein the interior volume 17 is dimensioned to receive a portable electronic device (as shown in FIG. 4, 18), such as a laptop computer, tablet, or the like therein. In this manner, the rigid housing can be inverted over the portable electronic device when not in use, such that the base 13 and the plurality of sidewalls 15 form a protective barrier between the portable electronic device and the surrounding area. The rigid nature of the laptop cover 11 ensures that impact damage and sustained weight applied to the laptop cover 11 is not transferred to the underlying portable electronic device, thereby minimizing the risk of damage thereto. In the shown embodiment, the base 13 further comprises a planar upper surface (as shown in FIG. 2, 14), wherein the planar upper surface provides a flat and stable support surface for other items while the portable electronic device is not in use.

The plurality of sidewalls further comprise a notch 19 therein, wherein the notch 19 is disposed through a lateral sidewall 30 of the plurality of sidewalls 15. The notch 19 is dimensioned to receive a cable therethrough, such that the portable electronic device can be encased by the laptop cover 11 while still connected to an external power source. In this manner, the user can easily protect and charge their electronic device simultaneously. The notch 19 is contemplated to be disposed through either or both of the lateral sidewalls 30 to facilitate use with various portable electronic device designs wherein the power source may be connected to either side of the laptop. Furthermore, in the illustrated embodiment, a plurality of feet 32 are disposed about a lower surface 33 of each of the plurality of sidewalls 15, wherein the plurality of feet 32 are configured to frictionally engage a support surface to retain the laptop cover 11 over the portable electronic device. In some embodiments, the plurality of feet 32 comprise a rubber material increasing frictional engagement with the support surface, while minimizing the risk of damaging the support surface due to lateral shifting of the laptop cover 11. In the shown embodiment, the plurality of feet 32 are isolated to each corner of the laptop cover 11 at the intersection between adjacent sidewalls of the plurality of sidewalls 15. In this manner, the plurality of feet 32 prevent shifting from multiple independent directions while minimizing the material required to ensure frictional engagement. In the shown embodiment, a handle 26 is affixed to a front sidewall 27 of the plurality of sidewalls 15, wherein the handle 26 provides a gripping surface to facilitate transport and use of the laptop cover 11. In the shown embodiment, the handle 26 comprises a flexible strap affixed to the front sidewall 27 on opposing ends of the handle 26.

Referring now to FIG. 2, there is shown a partial cutaway side perspective view of an embodiment of the laptop cover. The notch 19 is disposed through the lateral sidewall to provide a passage through which the power cable of the portable electronic device can extend. The notch 19 extends through a distal end 22 of the lateral sidewall defining an open lower end 21 of the notch 19. In this manner, user can simply rest the laptop cover over the electronic device while the power cable is affixed thereto. In the shown embodiment, the notch 19 defines an arcuate upper end 31 opposite the open lower end 21, wherein the arcuate upper end 31 provides a smooth rounded shape to minimize the risk of damage to the cable via hard corners. Similarly, the sidewall along the edges of the notch 19 are contemplated to be rounded to minimize sharp corners which may damage the power cable over extended contact.

In the illustrated embodiment, a padded layer 34 is affixed to an entire exterior of the laptop cover, wherein the padded layer 34 covers the planar upper surface 14 of the base 13 and the exterior surface of the plurality of sidewalls 15. In this manner, the padded layer 34 attenuates impacts occurring to the exterior of the laptop cover. Furthermore, the padded layer 34 provides a soft and comfortable surface for a user to rest arms thereon, or alternatively, for pets or other animals to rest upon while the portable electronic device is safely covered. In some embodiments, the padded layer 34 further extends along an entire lower surface of the plurality of sidewalls 15 such that the padded layer 34 minimizes the risk of scratching or otherwise damaging the support surface. In this manner, the padded layer 34 serves a similar function to the plurality of feet as previously described.

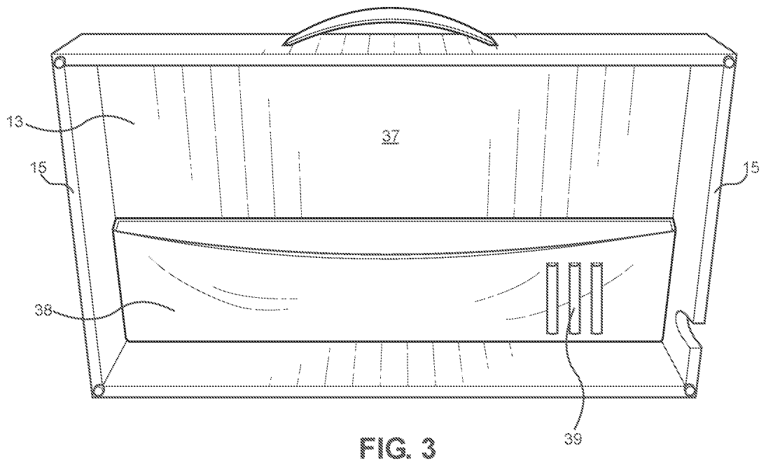

Referring now to FIG. 3, there is shown a lower plan view of an embodiment of the laptop cover. In the illustrated embodiment, the laptop cover further comprises a storage compartment on an interior surface 37 of the base 13. While alternate storage means are contemplated, such as elastic netting, retention clasps, or fasteners, in the shown embodiment, the storage compartment comprises a pocket 38 disposed across an entire length of the base 13. As the pocket 38 extends between opposing sidewalls of the plurality of sidewalls 15, the storage space provided thereby is maximized. The pocket 38 provides a storage receptacle for paperwork or other work-related accessories to aid a user in utilizing the electronic device. In the shown embodiment, a plurality of cylindrical receptacles 39 are disposed on an exterior surface of the pocket 38, wherein the plurality of cylindrical receptacles 39 are contemplated to retain writing utensils therein. In some embodiments, the plurality of cylindrical receptacles 39 are disposed on an interior surface of the pocket 38, or alternatively on the interior surface 37 of the base 13 within the interior volume of the pocket 38. In this manner, the plurality of cylindrical receptacles 39 and the associated writing utensils stored therein do not contact the laptop or other electronic device while the laptop cover is in use, thereby reducing the risk of scratching or otherwise damaging the electronic device.

Referring now to FIG. 4, there is shown a perspective view of an embodiment of the laptop cover in use. In one exemplary use, when a user wishes to stop using a laptop or other portable electronic device 18, the user can invert the laptop cover 11 over the portable electronic device 18 such that the portable electronic device 18 is disposed within the interior volume of the laptop cover 11. The user can ensure that the laptop cover 11 rests flush on the support surface by passing the power cable 20 of the portable electronic device 18 through the notch 19, allowing the plurality of sidewalls to rest parallel and flush with the support surface. In this manner, the planar upper surface 14 is parallel to the support surface, allowing a user to rest objects thereon and utilize the space occupied by the laptop cover 11 without damaging the portable electronic device 18. Once the user wishes to utilize the portable electronic device 18 again, the user can grasp the handle 26 to lift the laptop cover 11 from the support surface. In this manner, the laptop cover 11 provides a rigid, secure, and easily applied protective cover for a portable electronic device 18.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A laptop cover, comprising:
a rigid housing including a base having a planar upper surface;
a plurality of sidewalls extending from a perimeter of the base defining an open end opposite the base;
wherein an interior volume of the housing is dimensioned to receive a laptop computer therein;
a notch disposed through one sidewall of the plurality of sidewalls, wherein the notch is dimensioned to receive a cable therethrough;
wherein the notch includes an open lower end extending through a distal end of the sidewall.

2. The laptop cover of claim 1, wherein the base is rectangular, defining a front side and a rear side of identical length and a pair of lateral sides of identical length.

3. The laptop cover of claim 1, wherein a handle is affixed to a front sidewall of the plurality of sidewalls.

4. The laptop cover of claim 3, wherein the handle comprises a flexible strap affixed to the front sidewall at opposing ends of the flexible strap.

5. The laptop cover of claim 1, wherein the notch is disposed through a lateral sidewall of the plurality of sidewalls.

6. The laptop cover of claim 1, wherein the notch comprises an arcuate upper end.

7. The laptop cover of claim 1, further comprising a plurality of feet disposed along a lower surface of the plurality of sidewalls.

8. The laptop cover of claim 7, wherein the plurality of feet comprise a material configured to frictionally engage a support surface.

9. The laptop cover of claim 1, further comprising a padded layer disposed about an exterior of the housing.

10. A laptop cover, comprising:
a rigid housing including a base having a planar upper surface;
a plurality of sidewalls extending from a perimeter of the base defining an open end opposite the base;
wherein an interior volume of the housing is dimensioned to receive a laptop computer therein;
a storage compartment disposed within the interior volume on an interior surface of the base;
a notch disposed through one sidewall of the plurality of sidewalls, wherein the notch is dimensioned to receive a cable therethrough;
wherein the notch includes an open lower end extending through a distal end of the sidewall.

11. The laptop cover of claim 10, wherein the base is rectangular, defining a front side and a rear side of identical length and a pair of lateral sides of identical length.

12. The laptop cover of claim 10, wherein a handle is affixed to a front sidewall of the plurality of sidewalls.

13. The laptop cover of claim 12, wherein the handle comprises a flexible strap affixed to the front sidewall at opposing ends of the flexible strap.

14. The laptop cover of claim 10, wherein the notch is disposed through a lateral sidewall of the plurality of sidewalls.

15. The laptop cover of claim 10, wherein the notch comprises an arcuate upper end.

16. The laptop cover of claim 10, further comprising a plurality of feet disposed along a lower surface of the plurality of sidewalls.

17. The laptop cover of claim 16, wherein the plurality of feet comprise a material configured to frictionally engage a support surface.

18. The laptop cover of claim 10, further comprising a padded layer disposed about an exterior of the housing.

19. The laptop cover of claim 10, wherein the storage compartment comprises a pocket extending between opposing lateral sides of the base.

20. The laptop cover of claim 10, wherein the storage compartment includes a plurality of cylindrical receptacles.
